(19) United States
(12) Patent Application Publication
(10) Pub. No.: US 2022/0270354 A1
(43) Pub. Date: Aug. 25, 2022

(54) MONOCULAR IMAGE-BASED MODEL TRAINING METHOD AND APPARATUS, AND DATA PROCESSING DEVICE

(71) Applicant: GUANGZHOU HUYA TECHNOLOGY CO., LTD., Guangzhou (CN)

(72) Inventors: Pengpeng LIU, Guangzhou (CN); Jia XU, Guangzhou (GD)

(21) Appl. No.: 17/629,521

(22) PCT Filed: Jul. 27, 2020
(86) PCT No.: PCT/CN2020/104924

§ 371 Date: Jan. 24, 2022

(30) Foreign Application Priority Data
Aug. 15, 2019 (CN) 201910753810.7

(51) Int. Cl. G06V 10/774; G06V 10/776; G06T 3/00; G06V 10/75; G06T 7/30

(52) U.S. Cl. CPC G06V 10/7747; G06V 10/776; G06T 3/0093; G06V 10/751; G06T 7/30; G06T 2207/10012; G06T 2207/20081

(57) ABSTRACT

Provided are a monocular image-based model training method and apparatus, and a data processing device. The method includes: first obtaining a first training image and a second training image acquired at different time points by a monocular image acquisition apparatus; then obtaining a first optical flow prediction result from the first training image to the second training image according to a photometric loss between the first training image and the second training image; and taking the first optical flow prediction result as an agent label, and performing optical flow prediction training by using the first training image and the second training image.

### CROSS-REFERENCE TO RELATED APPLICATION

The present disclosure claims the priority to the Chinese patent application filed with the Chinese Patent Office on Aug. 15, 2019 with the filing No. 2019107538107, and entitled “Monocular Image-based Model Training Method and Apparatus, and Data Processing Device”, the contents of which are incorporated herein by reference in entirety.

### TECHNICAL FIELD

The present disclosure relates to the field of computer vision technologies, and in particular, provides a monocular image-based model training method and apparatus, and a data processing device.

### BACKGROUND ART

Binocular image alignment (stereo matching), belonging to the computer vision problems, is widely applied to the fields such as 3D digital scene reconstruction and automatic drive. The target of binocular image alignment is to predict displacement of pixels, i.e., stereo disparity map between two binocular images.

When dealing with the binocular image alignment problem, a convolutional neural networks (CNN) model may be used, the CNN model is trained through a large number of samples, and then the trained model is used to realize binocular image alignment.

As the cost of obtaining a binocular image training sample with a correct label is relatively high, in some embodiments, a synthesized simulation image can be used for training, but a model trained in this manner does not have favorable capability of identifying a real image. In some other embodiments, unlabeled binocular images may be used to warp a right image to a left image according to the disparity map obtained from prediction, and then the difference between the warped right image and left image is measured according to the photometric quantity loss, but this approach still requires a large number of corrected binocular images, and the training cost is relatively high.

### SUMMARY

An objective of the present disclosure lies in providing a monocular image-based model training method and apparatus, and a data processing device, which can realize self-supervised learning of stereo matching of binocular images without depending on corrected binocular image samples, and the same model is used for predicting optical flow and stereo matching.

In order to realize at least one of the above objectives, a technical solution adopted in the present disclosure is as follows.

An embodiment of the present disclosure provides a monocular image-based model training method, applied to train an image matching model, wherein the method includes:

obtaining a first training image and a second training image acquired by a monocular image acquisition apparatus at different time points;

obtaining a first optical flow prediction result from the first training image to the second training image according to a photometric loss between the first training image and the second training image;

performing, with the first optical flow prediction result as a proxy label, a proxy learning of optical flow prediction by using the first training image and the second training image; and

configuring the trained image matching model to perform binocular image alignment and optical flow prediction.

An embodiment of the present disclosure further provides a monocular image-based model training apparatus, applied to train an image matching model, wherein the apparatus includes:

an image acquisition unit, configured to obtain a first training image and a second training image acquired by a monocular image acquisition apparatus at different time points.

a first optical flow prediction module, configured to obtain a first optical flow prediction result from the first training image to the second training image according to a photometric loss between the first training image and the second training image; and

a second optical flow prediction module, configured to take the first optical flow prediction result as a proxy label, and perform proxy learning of optical flow prediction by using the first training image and the second training image.

An embodiment of the present disclosure further provides a data processing device, including a machine-readable storage medium and a processor, wherein the machine-readable storage medium stores machine-executable instructions, and the above monocular image-based model training method is implemented when the machine-executable instructions are executed by the processor.

An embodiment of the present disclosure further provides a computer-readable storage medium, on which a computer program is stored, wherein the above monocular image-based model training method is implemented when the computer program is executed by a processor.

### BRIEF DESCRIPTION OF DRAWINGS

FIG. 1 is a schematic block diagram of a data processing device provided in an embodiment of the present disclosure;

FIG. 2 is a schematic flowchart of steps of a monocular image-based model training method provided in an embodiment of the present disclosure;

FIG. 3 is a first schematic view of binocular image alignment principle provided in an embodiment of the present disclosure;

FIG. 4 is a second schematic view of binocular image alignment principle provided in an embodiment of the present disclosure;

FIG. 5 is a schematic view of image matching model processing provided in an embodiment of the present disclosure;

FIG. 6 is a schematic view of comparison of optical flow prediction test results on a same data set;

FIG. 7 is a schematic view of comparison of binocular image alignment test results on the same data set; and

FIG. 8 is a schematic view of modules of the monocular image-based model training device provided in an embodiment of the present disclosure.

### DETAILED DESCRIPTION OF EMBODIMENTS

In order to make the objectives, technical solutions, and beneficial effects of the embodiments of the present disclosure clearer, the technical solutions provided in the embodiments of the present disclosure will be exemplarily described below referring to the drawings.

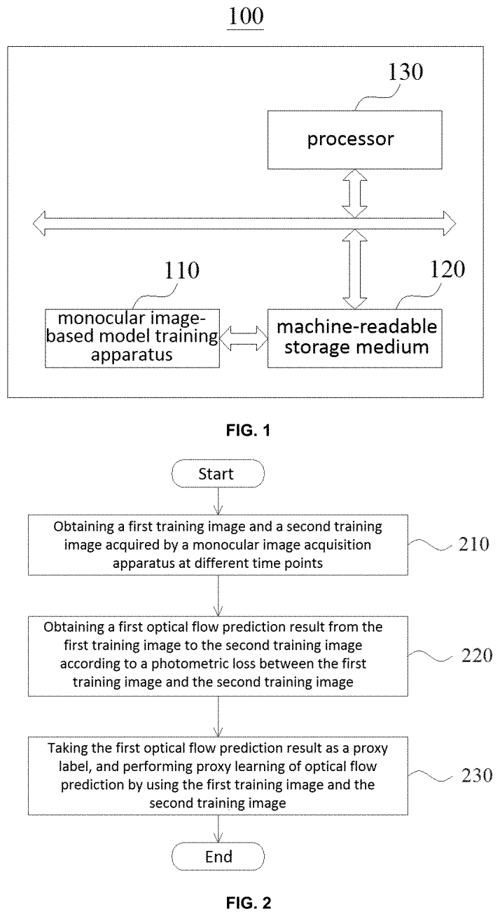

Referring to FIG. 1, FIG. 1 is a schematic view of a hardware structure of a data processing device 100 provided in an embodiment of the present disclosure. In some embodiments, the data processing device 100 may include a processor 130 and a machine-readable storage medium 120. The processor 130 and the machine-readable storage medium 120 may communicate via a system bus. Moreover, the machine-readable storage medium 120 stores machine-executable instructions (e.g., code instructions associated with an image model training apparatus 110), and the processor 130 may execute the monocular image-based model training method described above by reading and executing the machine-executable instructions in the machine-readable storage medium 120 corresponding to the image model training logic.

In some embodiments, the machine-readable storage medium 120 mentioned in the present disclosure may be any electronic, magnetic, optical or other physical storage means, and may contain or store information, for example, executable instructions and data. For example, the machine-readable storage medium may be: RAM (Radom Access Memory), volatile memory, nonvolatile memory, flash memory, memory driver (e.g. hard disk drive), solid state hard disk, memory disk of any type (e.g., optical disk and dvd), or similar storage medium, or combinations thereof.

Referring to FIG. 2, it is a schematic flowchart of a monocular image-based model training method provided in an embodiment of the present disclosure, and various steps included in the method will be exemplarily described below.

Step 210, obtaining a first training image and a second training image acquired by a monocular image acquisition apparatus at different time points.

Step 220, obtaining a first optical flow prediction result from the first training image to the second training image according to a photometric loss between the first training image and the second training image.

Step 230, performing, with the first optical flow prediction result as a proxy label, a proxy learning of optical flow prediction by using the first training image and the second training image.

In some embodiments, the binocular image alignment is generally a computer vision task of identifying the same object from two binocular images in a horizontal direction from stereo vision.

Optical flow prediction is a technology for determining movement of the same object in different frames of images according to the luminosity of the pixels based on the assumption of brightness constancy and space smoothness.

Proxy learning is a strategy that utilizes a created additional task to guide learning for a target task.

It has been found by the inventors through researches that binocular image alignment and optical flow prediction can be regarded as one type of problems, i.e., a matching problem of corresponding pixel points in an image. The main difference between the two lies in that the binocular image alignment is a one-dimensional search problem, and on the corrected binocular image, the corresponding pixel is located on an epipolar line. The optical flow prediction does not have such a constraint, and can be regarded as a two-dimensional search problem. Therefore, the binocular image alignment can be regarded as a special case of optical flow. If a pixel matching model that can be well executed in a two-dimensional scene is trained, it also can well realize the pixel matching task in a one-dimensional scene.

Therefore, in some embodiments, by executing step 210, the data processing device 100 can train an image matching model by taking two images acquired by the monocular image acquisition apparatus at different time points as training samples.

Exemplarily, for binocular image alignment, both left and right cameras of the binocular camera can acquire images simultaneously, and relative positions of the two cameras are generally fixed, therefore, according to this geometric characteristics, in a binocular image alignment process, for pixels on an epipolar line of the left image, the corresponding pixels should be located on an epipolar line of the right image, that is, this is a one-dimensional image matching problem.

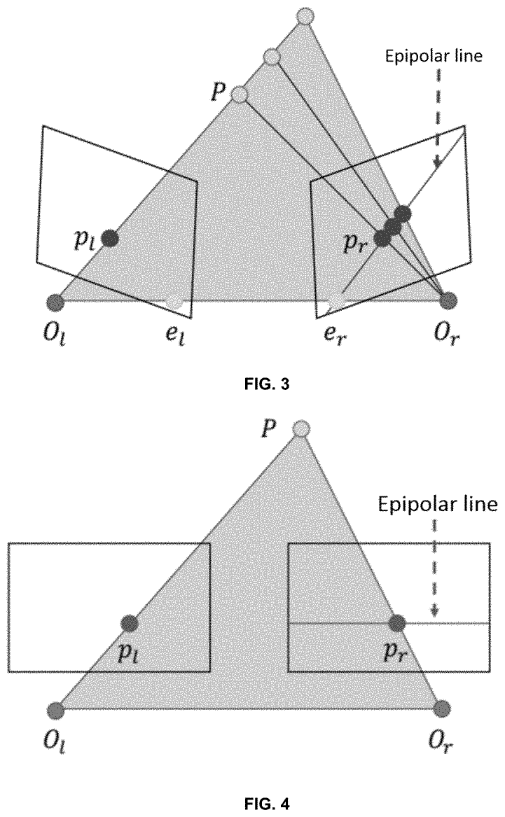

Referring to FIG. 3, a projection point of a point P in a three-dimensional scene in a left image of a binocular image is a pixel Pₗ, and a projection point in a right image is a pixel Pᵣ. When Pₗ is determined, the epipolar line passes through the left image epipolar point eₗ, and Pₗ is located on the epipolar line, then the pixel Pᵣ on the right image corresponding Pₗ is also always located on the epipolar line, and the epipolar line passes through the right image epipolar point eᵣ. In the above, Oₗ and Oᵣ are respectively centers of left and right cameras, and eₗ and eᵣ are epipolar points.

Referring to FIG. 4, FIG. 4 shows an example of binocular stereo image correction, the left and right cameras are parallel, and the epipolar lines are horizontal, that is, the binocular image alignment is to find matched pixels along a horizontal line.

In some embodiments, the optical flow generally describes dense movement between two adjacent frames. The two images are taken at different times, and the camera position and pose between the two frames may be changed. The optical flow prediction scene may be a rigid scene or a non-rigid scene. For the rigid scene, the object in the scene does not move, and the difference between images is merely due to movement (rotation or translation) of the camera, then the optical flow prediction may also become a one-dimensional image matching problem along the epipolar line. The binocular image is a picture captured at different angles at the same time, and the binocular image alignment problem can be regarded as an optical flow prediction problem in a rigid scene where a camera, after shooting at a position, moves to shoot again at another position, and then two images are processed.

Since the estimation of self-movement itself will result in additional errors and the scene is not always rigid, in some embodiments, the problem of self-movement of the camera may be not considered, and the binocular image alignment is taken only as a special case of optical flow prediction. That is to say, if the image matching model can achieve good optical flow prediction in a two-dimensional space, binocular image alignment should also be well realized in a one-dimensional space.

Therefore, in some embodiments, when the data processing device 100 executes step 220, in the process of optical flow prediction, the data processing device 100 may warp a target image to a reference image according to the predicted optical flow, and construct the photometric loss by measuring the difference between the warped target image and the reference image. However, for a pixel corresponding to an object occluded by foreground in the scene, the photometric constancy assumption is no longer established, and therefore, for an occluded pixel, the photometric loss may cause erroneous training supervision. To this end, in some embodiments, the occluded pixel may be predetermined and excluded when predicting the optical flow by employing the photometric loss.

In the above, it can be understood that, if a pixel point is only visible in one frame of picture, and is invisible in another frame of picture, the pixel point is occluded. There may be a plurality of reasons for the pixel point to be occluded, for example, movement of an object or movement of a camera, all of which may cause the pixel point to be occluded. For example, in some possible application scenes, a certain object in a first frame faces forward, and a camera captures a front part of the object; but in a second frame, the object is rotated to face backward, then the camera can only capture a back part of the object, in this way, the front half part of the object in the first frame, invisible in the second frame, is occluded.

Exemplarily, in some embodiments, the data processing device 100 may obtain an initial optical flow map and an initial confidence-degree map from the first training image to the second training image according to a photometric loss between the first training image and the second training image, and then obtain the first optical flow prediction result after the occluded pixel is excluded according to the initial optical flow map and the initial confidence-degree map, wherein the initial optical flow map may indicate a displacement amount of a corresponding pixel point between the first training image and the second training image; and the first optical flow prediction result may indicate a displacement amount of an unoccluded pixel point between the first training image and the second training image.

In addition, the initial confidence-degree map may be configured to indicate an occlusion state of the corresponding pixel point, for example, the confidence degree of the occluded pixel in the initial confidence-degree map may be set to be 0, and the confidence degree of the unoccluded pixel may be set to be 1. Then, the first optical flow prediction result is obtained according to the initial optical flow map and the initial confidence-degree map.

As the confidence degree of the unoccluded pixel is 0, when the initial optical flow map is multiplied by the initial confidence-degree map, that is, data of the occluded pixel is removed from the initial optical flow map, an optical flow map of high confidence degree constituted by unoccluded pixels is obtained.

Optionally, in some embodiments, the data processing device 100 may process the initial optical flow map by using forward-backward photometric detection, and determine the confidence degree corresponding to each pixel point according to the photometric difference to obtain the confidence-degree map. In the above, the data processing device 100 may set the confidence degree of a pixel with photometric difference exceeding a preset threshold to be 0, as an occluded pixel; and the data processing device 100 may set the confidence degree of a pixel with photometric difference not exceeding a preset threshold to be 1, as an unoccluded pixel.

In some embodiments, when the data processing device 100 performs the forward-backward photometric detection, forward optical flow F_{t→t+1}(p) and backward optical flow F′_{t→t+1}(p) of pixel p on the initial optical flow map from the first training image Iₜ to the second training image Iₜ₊₁ may be obtained, wherein F′_{t→t+1}(p)=F_{t+1→t}(p+F_{t→t+1}(p)), and F_{t+1→t} is initial optical flow from the second training image to the first training image.

The data processing device 100 may obtain the confidence-degree map M_{t→t+1}(p) of the pixel p according to the forward optical flow and the backward optical flow of the pixel p according to the following formula:

$${M}_{t \to t + 1} ( p ) = \{ \begin{matrix}1 , \vert {F}_{t \to t + 1} ( p ) + {F}_{t \to t + 1}^{′} ( p ) \vert \leq δ ( p ) \\ 0 , \vert {F}_{t \to t + 1} ( p ) + {F}_{t \to t + 1}^{′} ( p ) \vert > δ ( p )\end{matrix}$$

In the above, p represents a pixel point, δ(p)=0.1(|F_{t→t+1}(p)+F′_{t→t+1}(p)|)+0.05.

In addition, in some embodiments, the data processing device 100 may also exchange the first training image and the second training image for training, so as to obtain a reverse optical flow map from the second training image to the first training image.

In the above, when executing step 220, the data processing device 100 may perform optical flow prediction from the first training image to the second training image according to preset photometric loss function and smoothness loss function, to obtain the first optical flow prediction result.

Exemplarily, the photometric loss function Lₚ may be expressed as:

$${L}_{p} = \frac{{Σ}_{p} \vert Hamming ( {I}_{t}^{c} ( p ) - {\hat{I}}_{t + 1 \to t}^{c} ( p ) ) ⊙ {M}_{t \to t + 1} ( p ) \vert}{{Σ}_{p} {M}_{t \to t + 1} ( p )}$$

In the above, p represents a pixel point, Iₜ^{c} is an image obtained by changing the first training image Iₜ with Census, Î_{t+1→t}^{c} is a warp image obtained by warping Iₜ₊₁^{c} to Iₜ^{c} according to a forward optical flow from the first training image to the second training image, and Hamming(x) is a hamming distance.

The form of the smoothness loss function Lₘ may be:

$${L}_{m} = \frac{1}{N} {\sum }_{p} {\vert {e}^{- ∇ I ( p )} \vert}^{T} \cdot \vert ∇ F ( p ) \vert$$

In the above, I(p) is a pixel point on the first training image or the second training image, N is a total number of pixels of the first training image or the second training image, ∇ represents gradient, T represents transposition, I(p) is a pixel point on the first training image or the second training image, and F(p) is a point on the currently processed optical flow map.

When executing step 220, the data processing device 100 may take Lₚ+λLₘ as a loss function to train the image matching model, where λ=0.1.

Besides, in the above step 230, the CNN still may learn a better optical flow prediction on the KITTI dataset even if there is only a sparse correct label. Therefore, in some embodiments, the data processing device 100 may first obtain sparse high-confidence-degree optical flow prediction by executing step 220, and then use them as proxy label to guide the learning of the image matching prediction.

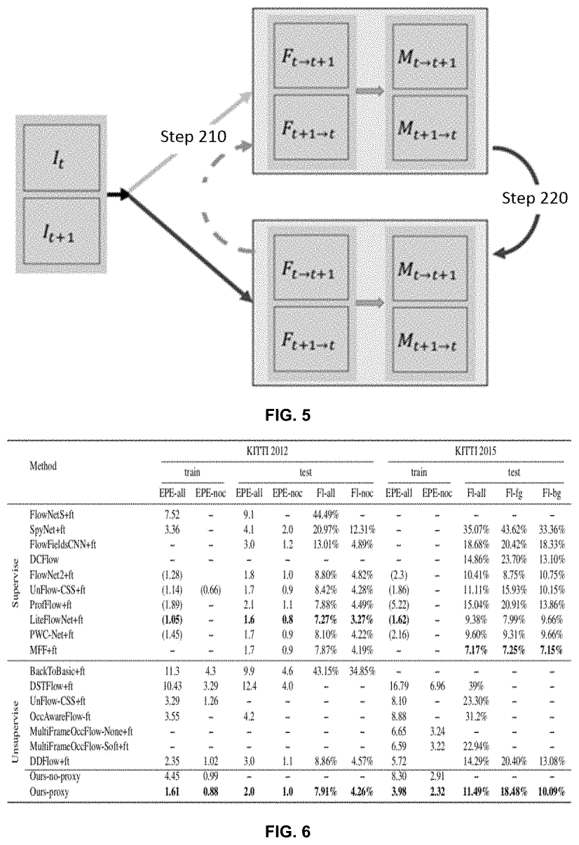

Referring to FIG. 5, in some embodiments, the data processing device 100 may use the first optical flow prediction result as a proxy label, and use preset proxy self-supervised loss function and smoothness loss function to perform the optical flow prediction from the first training image to the second training image.

Exemplarily, the form of the proxy self-supervised loss function Lₛ may be:

$${L}_{s} = \frac{{Σ}_{p} \vert ( F ( p ) + {F}^{py} ( p ) ) ⊙ {Σ}_{p} {M}^{py} ( p ) \vert}{{Σ}_{p} {M}^{py} ( p )}$$

In the above, p represents a pixel point, F^{py} is the initial optical flow map, M^{py} is the initial confidence-degree map, and F is the currently processed optical flow map.

When executing step 230, the data processing device 100 may use Lₛ+λLₘ as a loss function to train the image matching model, where λ=0.1.

It should be noted that, unlike the training process of executing step 220, when executing step 230, the data processing device 100 may no longer execute the removing action on the unoccluded pixel, so that the model can predict the optical flow of the occluded area.

Optionally, in some embodiments, when executing step 230, the data processing device 100 can first perform the same preprocessing on the first training image and the second training image at random, for example, in some embodiments, the preprocessing may be cutting the first training image and the second training image at the same position by the same size, or performing the same random downsampling, or in some other embodiments, the preprocessing may be cutting the first training image and the second training image at the same position by the same size, and performing the same random downsampling; then, the data processing device 100 may use the preprocessed first training image and second training image to perform the training of step 230, so that the effect of simultaneously improving optical flow prediction accuracy of occluding point and occluded point can be achieved.

Optionally, in some embodiments, when executing step 230, the data processing device 100 also may first perform random scaling of the same coefficient or random rotation of the same angle on the first training image and the second training image, and then use the processed first training image and second training image to execute the training of step 230.

It should be noted that, in some other possible embodiments of the present disclosure, the data processing device 100 may also obtain high-confidence-degree optical flow prediction by other methods. For example, reliable disparity (parallax error) is calculated by the conventional methods.

In some scenes, it is optical flow prediction that the model eventually needs to perform, therefore, the data processing device 100 obtains the optical flow prediction result and the confidence-degree map through step 220, and then when executing step 230, uses the high confidence-degree optical flow prediction as proxy basic fact to guide the neural network to learn image matching, and the above training process can be completed in one model.

In some embodiments, after having undergone the proxy learning, the number of high confidence-degree pixels will be increased, therefore, after executing step 230, the data processing device 100 further can use the second optical flow prediction result obtained by the proxy learning to perform iteration training, so as to improve identification capability of the image matching model.

It should be noted that, the image matching model obtained through the training with the method provided in the embodiment of the present disclosure not only can be configured to perform optical flow prediction, but also can be configured to perform binocular image alignment. When the trained image matching model performs the optical flow prediction, the first training image Iₜ to the second training image Iₜ₊₁ acquired at different time points can be used as input to output the optical flow map of Iₜ to Iₜ₊₁. When the trained image matching model is configured for binocular image alignment, images Iₗ and Iᵣ acquired by the left and right cameras in the binocular image may be taken as input, and stereo disparity maps of output images Iₗ to Iᵣ may be obtained as a matching result.

In some embodiments, the image matching model may be established on TensorFlow system using an Adam optimizer, and batch size of the model is set to be 4, an initial learning rate is 1e-4, and it is attenuated by half every 60 k times of iteration. During the training, standardized images may be input and data enhancement may be performed in a manner such as random cutting, scaling, or rotation. Exemplarily, a cutting size may be set to be [256,640] pixel size, and a random scaling coefficient range may be set to be [0.75, 1.25].

In addition, when executing step 220, the data processing device 100 may apply the photometric loss to all pixels, and the image matching model is trained by using the photometric loss, and 100 k times of iteration are performed from the start. It should be noted that, at the beginning, the high confidence-degree pixels and the low confidence-degree pixels may not be distinguished, because merely applying the photometric loss directly to the high confidence-degree pixel may result in a trivial solution that all the pixels are considered as low confidence-degree pixels. Thereafter, the image matching model is trained by 400 k times of iteration with the photometric loss function Lₚ and the smoothness loss function Lₘ. When executing step 230, the data processing device 100 may perform 400 k times of iteration by using a proxy self-supervised loss function Lₛ and a smoothness loss function Lₘ so as to train the image matching model.

FIG. 6 shows test results of optical flow prediction performed by using other models and the image matching model trained by using the method provided in the embodiment of the present disclosure on KITTI 2012 dataset and KITTI 2015 dataset, and it can be seen from FIG. 6 that the identification capability of the image matching model (“Our+proxy” item) trained by using the monocular image-based model training method provided in the embodiment of the present disclosure is significantly superior to that of the model trained by the unsupervised method such as MultiFrameOccFlow and DDFlow.

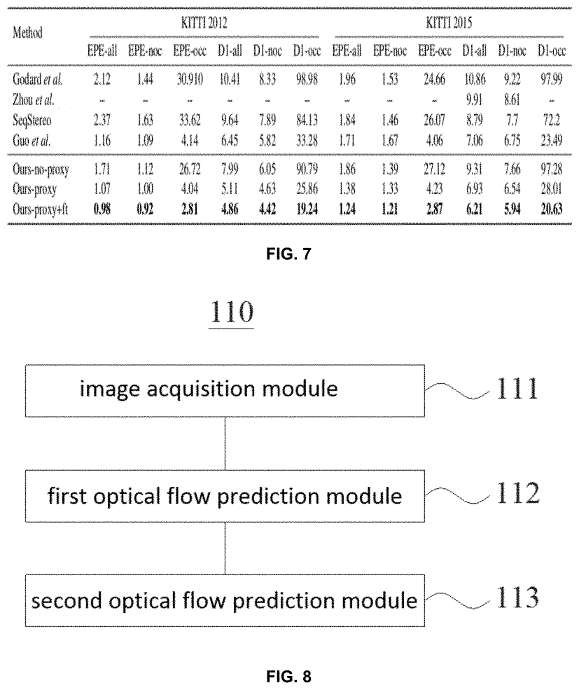

FIG. 7 shows test results of binocular image alignment performed by using other models and the image matching model trained by using the method provided in the embodiment of the present disclosure on KITTI 2012 dataset and KITTI 2015 dataset, and it can be seen from FIG. 7 that the identification capability of the image matching model (“Our+proxy+ft” item) trained by the monocular image-based model training method provided in the embodiment of the present disclosure is significantly superior to that of other models trained by the unsupervised method.

Referring to FIG. 8, an embodiment of the present disclosure further provides a monocular image-based model training apparatus 110, wherein the apparatus includes an image acquisition module 111, a first optical flow prediction module 112, and a second optical flow prediction module 113.

The image acquisition unit 111 is configured to obtain a first training image and a second training image acquired by a monocular image acquisition apparatus at different time points.

The first optical flow prediction module 112 is configured to obtain a first optical flow prediction result from the first training image to the second training image according to a photometric loss between the first training image and the second training image.

The second optical flow prediction module 113 is configured to take the first optical flow prediction result as a proxy label, and perform proxy learning of optical flow prediction by using the first training image and the second training image.

To sum up, for the monocular image-based model training method and apparatus, and the image processing device provided in the present disclosure, by taking the binocular image matching as a special case of optical flow prediction, by means of proxy learning, a first optical flow prediction result obtained by taking the two monocular images acquired at different time points as training samples is taken as a proxy label, and is configured to guide a model to perform optical flow prediction learning again. Therefore, the self-supervised learning of binocular image stereo matching can be achieved without depending on the corrected binocular image samples, and the optical flow prediction and stereo matching are performed by using the same model.

In the embodiments provided in the present disclosure, it should be understood that the apparatus and the method disclosed also may be implemented in other manners. The apparatus embodiments described above are merely illustrative, for example, the flowcharts and the block diagrams in the drawings show possible system structures, functions, and operations of the apparatus, method, and computer program products according to multiple embodiments of the present disclosure. In this regard, each block in the flowcharts or the block diagrams may represent one module, program segment, or a part of code, and the module, program segment, or a part of code contains one or more executable instructions configured to achieve a specified logical function. It also should be noted that in some embodiments as substitution, the functions indicated in the blocks also may take place in an order different from that indicated in the drawings. For example, two continuous blocks practically can be executed substantially in parallel, and they sometimes also may be executed in a reverse order, which depends upon a function involved. It also should be noted that each block in the block diagrams and/or flowcharts, and combinations of the blocks in the block diagrams and/or the flowcharts can be realized by a dedicated hardware- based system configured to execute a specified function or action, or can be realized by a combination of dedicated hardware and computer instructions.

Besides, various functional modules in various embodiments of the present disclosure can be integrated together to form one independent portion, and it is also possible that various modules exist independently, or that two or more modules are integrated to form an independent part.

If the function is realized in a form of software functional module and is sold or used as an independent product, it may be stored in one computer-readable storage medium. Based on such understanding, the technical solutions in essence or parts making contribution to the prior art or parts of the technical solutions of the present disclosure can be embodied in form of a software product, and this computer software product is stored in a storage medium, including several instructions for making a computer device (which can be a personal computer, a server or a network device, etc.) execute all or part of the steps of the methods of various embodiments of the present disclosure. The aforementioned storage medium includes various media in which program codes can be stored, such as U disk, mobile hard disk, Read-Only Memory (ROM), Random Access Memory (RAM), diskette and compact disk.

It should be indicated that in the present text, relational terms such as first and second are merely for distinguishing one entity or operation from another entity or operation, while it is not required or implied that these entities or operations necessarily have any such practical relation or order. Moreover, terms “including”, “containing” or any other derivatives thereof are intended to be non-exclusive, thus a process, method, article or device including a series of elements not only include those elements, but also include other elements that are not listed definitely, or further include elements inherent to such process, method, article or device. Without more restrictions, an element defined with wordings “including a . . . ” does not exclude presence of other same elements in the process, method, article or device including said element.

### INDUSTRIAL APPLICABILITY

By taking the binocular image matching as a special case of optical flow prediction, by means of proxy learning, the optical flow prediction result obtained by taking the two monocular images acquired at different time points as training samples is taken as a proxy label to guide a model to perform optical flow prediction learning again. Therefore, the self-supervised learning of binocular image stereo matching can be achieved without depending on the corrected binocular image samples, and the optical flow prediction and stereo matching are performed by using the same model.

1. A monocular image-based model training method, applicable to training an image matching model, wherein the method comprises steps of:
obtaining a first training image and a second training image acquired by a monocular image acquisition apparatus at different time points;
obtaining a first optical flow prediction result from the first training image to the second training image according to a photometric loss between the first training image and the second training image;
performing, with the first optical flow prediction result as a proxy label, proxy learning of optical flow prediction by using the first training image and the second training image;
making a trained image matching model configured to perform binocular image alignment and optical flow prediction.

2. The method according to claim 1, wherein the method further comprises steps of:
inputting a binocular image to be processed into the trained image matching model;
obtaining a stereo disparity map output by the image matching model for the binocular image to be processed.

3. The method according to claim 1, wherein the step of obtaining a first optical flow prediction result from the first training image to the second training image comprises steps of:
obtaining an initial optical flow map and an initial confidence-degree map from the first training image to the second training image according to a photometric loss between the first training image and the second training image;
obtaining the first optical flow prediction result after an occluded pixel is excluded according to the initial optical flow map and the initial confidence-degree map.

4. The method according to claim 3, wherein a manner of obtaining the initial confidence-degree map comprises a step of:
processing the initial optical flow map by using forward-backward photometric detection, and determining confidence degree corresponding to each pixel point according to photometric difference to obtain the confidence-degree map,
wherein confidence degree of a pixel with photometric difference exceeding a preset threshold is set to be 0, as an occluded pixel; and confidence degree of a pixel with photometric difference not exceeding the preset threshold is set to be 1, as an unoccluded pixel.

5. The method according to claim 4, wherein the step of processing the initial optical flow map by using forward-backward photometric detection, and determining confidence degree corresponding to each pixel point according to photometric difference to obtain the confidence-degree map comprises steps of:
obtaining forward optical flow F_{t→t+1}(p) and backward optical flow F′_{t→t+1}(p) of a pixel p on an initial optical flow map from a first training image Iₜ to a second training image Iₜ₊₁, wherein F′_{t→t+1}(p)=F_{t+1→t}(p+F_{t→t+1}(p)) and F_{t+1→t} is initial optical flow from the second training image to the first training image;
obtaining a confidence-degree map M_{t→t+1}(p) of the pixel p according to the forward optical flow and the backward optical flow of the pixel p according to a following formula:
$${M}_{t \to t + 1} ( p ) = \{ \begin{matrix}1 , \vert {F}_{t \to t + 1} ( p ) + {F}_{t \to t + 1}^{′} ( p ) \vert \leq δ ( p ) \\ 0 , \vert {F}_{t \to t + 1} ( p ) + {F}_{t \to t + 1}^{′} ( p ) \vert > δ ( p )\end{matrix} \\ where δ ( p ) = 0.1 ( \vert {F}_{t \to t + 1} ( p ) + {F}_{t \to t + 1}^{′} ( p ) \vert ) + 0.05 .$$

6. The method according to claim 5, wherein the step of obtaining the first optical flow prediction result according to the initial optical flow map and the initial confidence-degree map comprises a step of:
performing optical flow prediction from the first training image to the second training image according to preset photometric loss function and smoothness loss function, to obtain the first optical flow prediction result.

7. The method according to claim 6, wherein a form of the photometric loss function Lₚ is:
$${L}_{p} = \frac{{Σ}_{p} \vert Hamming ( {I}_{t}^{c} ( p ) - {\hat{I}}_{t + 1 \to t}^{c} ( p ) ) ⊙ {M}_{t \to t + 1} ( p ) \vert}{{Σ}_{p} {M}_{t \to t + 1} ( p )}$$
where Iₜ^{c} is an image obtained by changing the first training image Iₜ with Census, Î_{t+1→t}^{c} is a warp image obtained by warping Iₜ₊₁^{c} to Iₜ^{c} according to a forward optical flow from the first training image to the second training image, and Hamming(x) is a hamming distance.

8. The method according to claim 6, wherein a form of the smoothness loss function Lₘ is:
$${L}_{m} = \frac{1}{N} {\sum }_{p} {\vert {e}^{- ∇ I ( p )} \vert}^{T} \cdot \vert ∇ F ( p ) \vert$$
where I(p) is a pixel point on the first training image or the second training image, N is a total number of pixels of the first training image or the second training image, ∇ represents gradient, T represents transposition, I(p) is a pixel point on the first training image or the second training image, and F(p) is a point on a currently processed optical flow map.

9. The method according to claim 5, wherein the step of performing with the first optical flow prediction result as a proxy label a proxy learning of optical flow prediction by using the first training image and the second training image comprises a step of:
using, with the first optical flow prediction result as a proxy label, a preset proxy self-supervised loss function and a smoothness loss function to perform the optical flow prediction from the first training image to the second training image.

10. The method according to claim 9, wherein a form of the proxy self-supervised loss function Lₛ is:
$${L}_{s} = \frac{{Σ}_{p} \vert ( F ( p ) + {F}^{py} ( p ) ) ⊙ {Σ}_{p} {M}^{py} ( p ) \vert}{{Σ}_{p} {M}^{py} ( p )}$$
where F^{py} is the initial optical flow map, M^{py} is the initial confidence-degree map, and F is a currently processed optical flow map.

11. The method according to claim 9, wherein the step of using with the first optical flow prediction result as a proxy label a preset proxy self-supervised loss function and a smoothness loss function to perform the optical flow prediction training from the first training image to the second training image comprises steps of:
performing the same preprocessing on the first training image and the second training image, wherein the preprocessing comprises random cutting and/or random downsampling;
performing, with the first optical flow prediction result as a proxy label, machine learning training of image element matching by using preprocessed first training image and second training image.

12. The method according to claim 9, wherein the step of using with the first optical flow prediction result as a proxy label a preset proxy self-supervised loss function and a smoothness loss function to perform the optical flow prediction training from the first training image to the second training image comprises steps of:
performing the same preprocessing on the first training image and the second training image, wherein the preprocessing comprises random scaling of coefficient or random rotation of angle;
performing, with the first optical flow prediction result as a proxy label, machine learning training of image element matching by using preprocessed first training image and second training image.

13. The method according to claim 1, wherein after the step of performing with the first optical flow prediction result as a proxy label a proxy learning of optical flow prediction by using the first training image and the second training image, the method further comprises:
using a second optical flow prediction result obtained by the proxy learning to perform iteration training.

14. A monocular image-based model training apparatus, applicable to training an image matching model, wherein the apparatus comprises:
an image acquisition unit, configured to obtain a first training image and a second training image acquired by a monocular image acquisition apparatus at different time points;
a first optical flow prediction module, configured to obtain a first optical flow prediction result from the first training image to the second training image according to a photometric loss between the first training image and the second training image;
a second optical flow prediction module, configured to perform, with the first optical flow prediction result as a proxy label, proxy learning of optical flow prediction by using the first training image and the second training image.

15. A data processing device, comprising a machine-readable storage medium and a processor, wherein the machine-readable storage medium stores machine-executable instructions, and the method according to claim 1 is implemented when the machine-executable instructions are executed by the processor.

16. (canceled)
